(19) United States
(12) Patent Application Publication
(10) Pub. No.: US 2007/0124030 A1
(43) Pub. Date: May 31, 2007

(54) Systems for determining movement amount

(75) Inventors: Toshihiro Mori, Okazaki-shi (JP); Tomoki Kubota, Okazaki-shi (JP); Hiroaki Sugiura, Okazaki-shi (JP); Hideto Miyazaki, Anjo-shi (JP)

Correspondence Address: OLIFF & BERRIDGE, PLC, P.O. BOX 19928, ALEXANDRIA, VA, 22320, US

(73) Assignee: AISIN AW CO., LTD., ANJO-SHI (JP)

(21) Appl. No.: 11/592,295

(22) Filed: Nov. 3, 2006

(30) Foreign Application Priority Data
Nov. 4, 2005 (JP) 2005-320602

(51) Int. Cl. G05D 1/00; G06K 9/00

(52) U.S. Cl. 701/1; 382/104

(57) ABSTRACT

Systems for determining a movement amount detect a steering angle of a moving body on which a camera is mounted and extract matching inspection areas of a prescribed shape and size from frames captured by a camera. The systems rotate the inspection area of a second frame relative to the inspection area of a first frame, the rotation based on the detected steering angle. The systems execute pattern matching between the inspection areas and calculate positions of subject points that correspond to identical characteristic points in each frame. The systems, methods, and programs determine the movement amount based on a displacement amount between the calculated subject point positions.

The disclosure of Japanese Patent Application No. 2005-320602 filed on Nov. 4, 2005, including the specification, drawings, and abstract is incorporated herein by reference in its entirety.

### BACKGROUND

1. Related Technical Fields

Related technical fields include systems and methods that determine a movement amount or a movement distance of a moving body such as an automobile or the like.

2. Description of the Related Art

Japanese Patent Application Publication No. JP-A-6-020052 discloses determining a vehicle position based on a movement amount of corresponding image points in two temporally sequential images. The images are taken by a CCD camera that faces forward and is fixed to an automobile. The determined vehicle position for is used in vehicle control and display control. According to the disclosed method, the computation of image point positions is simplified by limiting the object of observation in image processing to a portion of an image.

### SUMMARY

The method of Japanese Patent Application Publication No. JP-A-6-020052 cannot adequately determine a vehicle's movement when the vehicle on which a camera is mounted travels in curved line. According to the method of Japanese Patent Application Publication No. JP-A-6-020052, it cannot be expected that identical characteristic points in two different frames will necessarily line up in the vertical direction on a screen. Therefore, searching in the screen must be done not only in the vertical direction, but in all directions, increasing the processing load.

Exemplary implementations of broad principles disclosed herein provide systems and methods that may determine a movement amount (a length of a movement path) or a movement distance (a length of a straight line connecting two points) based on images captured from a device mounted on a moving body that moves freely, for example, when the moving body travels in a curved line.

Exemplary implementations provide systems, methods, and programs that may detect a steering angle of a moving body on which a camera is mounted and may extract matching inspection areas of a prescribed shape and size from frames captured by a camera. The systems, methods, and programs may rotate the inspection area of a second frame relative to the inspection area of a first frame, the rotation based on the detected steering angle. The systems, methods, and programs may execute pattern matching between the inspection areas and may calculate positions of subject points that correspond to identical characteristic points in each frame. The systems, methods, and programs determine the movement amount based on a displacement amount between the calculated subject point positions.

### BRIEF DESCRIPTION OF THE DRAWINGS

Exemplary implementations will now be described with reference to the accompanying drawings, wherein:

FIG. 1A is a block diagram showing an exemplary movement amount computation system.

FIG. 1B is an explanatory drawing showing a relationship between an image range photographed by an exemplary on-board camera and an image capture range on a road surface.

FIG. 2 is a flowchart showing an exemplary method for computing a movement amount.

FIG. 3 is an explanatory drawing showing how an example of how matching inspection area is extracted from a frame and how pattern matching is done using data in the matching inspection area.

FIG. 4 is an explanatory drawing showing an exemplary technique for determining a movement amount by approximating the movement as a circular arc that follows a movement path that takes a vehicle's turning into consideration.

### DETAILED DESCRIPTION OF EMBODIMENTS

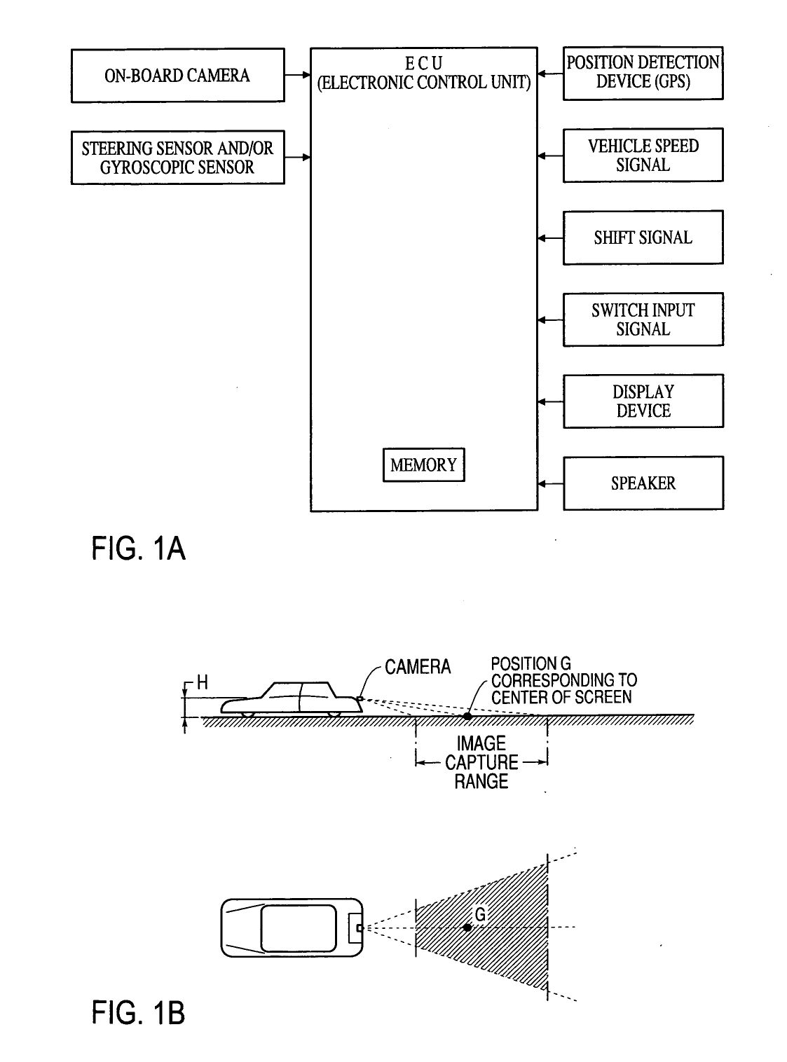

FIG. 1A shows an exemplary movement amount computation system. As shown in FIG. 1A, the exemplary system may include signal inputs and outputs for a car navigation system. The movement amount computation system may, for example, be installed as a part of a publicly known car navigation system. That is, the movement amount computation system may include, for example, a processing program that executes procedures that are described below and hardware such as an on-board camera and the like.

In the exemplary car navigation system, as shown in the drawing, signals are may be into a controller, such as, for example, a publicly known electronic control unit (ECU) from a variety of devices. Such devices may include, for example, an on-board camera (e.g., mounted on the rear of the vehicle in the example in FIG. 1B), a steering sensor that detects a steering angle (or a gyroscopic sensor that detects rotation), a Global Positioning System (GPS) position detection device, and the like. A vehicle speed signal that may be obtained, for example, based on a revolution speed of a wheel; a shift signal that, for example, indicates various gear positions, such as reverse gear, drive gear, and the like; as well as signals from various types of switches, such as a movement amount computation system on-off switch, may also be input into the exemplary system. The input signals may be processed, for example, according to programs that correspond to designated functions, and thereby the various designated functions may be executed. For example, when a movement amount computation function is designated, a program to execute the movement amount computation function may be read from a memory, such as a ROM (not shown), and executed, thereby executing the movement amount computation function.

Appropriate data may be output, for example, from the ECU to the car navigation system display device or speaker, and appropriate displays or audio may be output.

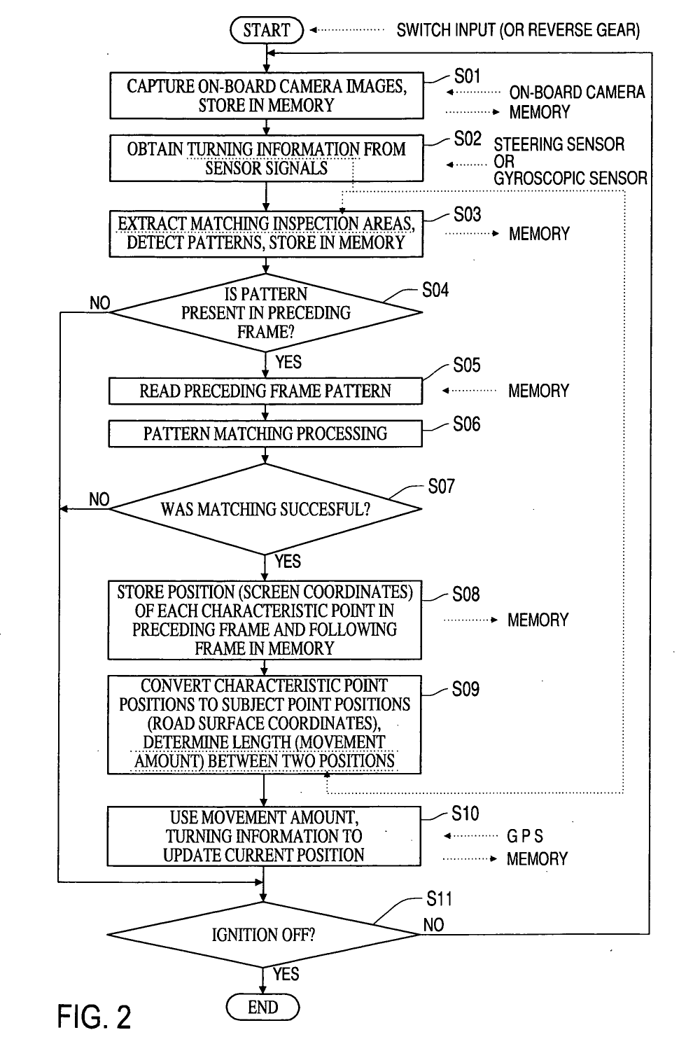

FIG. 2 an exemplary method for computing a movement amount. The exemplary methods may be implemented, for example, by one or more components of the above-described system. However, even though the exemplary structure of the above-described system may be referenced in the description, it should be appreciated that the structure is exemplary and the exemplary method need not be limited by any of the above-described exemplary structure.

The exemplary method (S01 to S10) may be started according to a predetermined event, such as, for example, an input from a switch that turns the movement amount computation function on or in response to the transmission being shifted into reverse gear. Also, the exemplary method may ends upon an input from a switch that turns the movement amount computation function off or in response to the transmission being shifted from reverse gear to another gear. The method may also end, for example, in response to an ignition switch being turned off (e.g., YES at S11).

As shown in FIG. 2, at S01, images are captured, for example, by the on-board camera and stored in a prescribed area in memory (an area for frame memory). Next, at S02, turning information is created, for example, based on a detection signal from the steering sensor (or the gyroscopic sensor) and stored in memory.

The turning information may be information that provides, for example, an angle at which a matching inspection area that is to be extracted from a following image frame should be rotated in relation to a matching inspection area that has been extracted from a preceding image frame, the preceding frame being an image frame taken at a time preceding the time that the following image frame was taken. In this manner, identical characteristic points in the preceding frame and the following frame may be lined up in the vertical direction in matching inspection areas extracted from both frames.

The turning information may be, for example, the difference between the steering angle of the front wheels when the preceding frame is captured and the steering angle of the front wheels when the following frame is captured. In this case, the steering angle datum is set to zero degrees when the vehicle is moving straight forward. The average of the front-wheel steering angle when the preceding frame is captured and the front-wheel steering angle when the following frame is captured may also be used. Note that an automobile does not turn at the same angle as the steering angle, but rather turns around a prescribed position (an axis of rotation) that is in a prescribed relationship to the steering angle. Therefore, more accurate turning information may be obtained by factoring this requirement in and correcting for it.

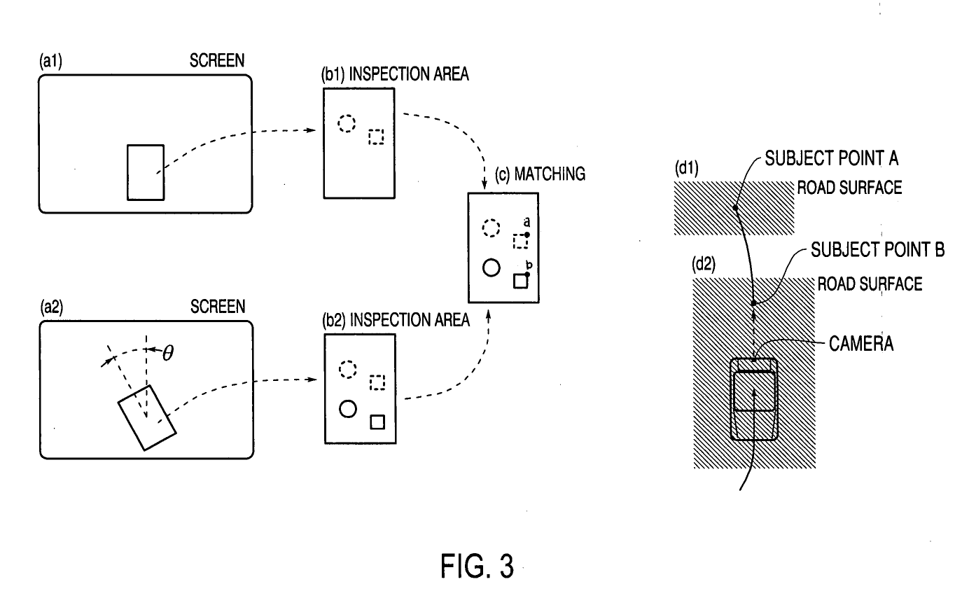

In S03, using the turning information obtained at step S02 above, the system extracts matching inspection areas from the images stored in frame memory at step S01. That is, the system extracts a matching inspection area from the following frame by rotating the area in relation to the preceding frame by an angle q that is provided by the turning information. This process is shown, for example, in (a2) to (b2) in FIG. 3. As shown (a2) to (b2), the matching inspection area in the current frame (the rectangular area in (a2) in FIG. 3) is rotated in relation to the matching inspection area in the preceding frame (the rectangular area in (a1) in FIG. 3) by the angle θ and extracted.

Also at S03, a pattern to be used for pattern matching is detected in the extracted matching inspection area, for example, by executing prescribed image processing (e.g., Fourier transforms, binarization processing, edge processing, and the like), and the pattern is stored in memory.

At S04, the system checks whether or not a pattern is present in the preceding frame. If a pattern is present in the preceding frame (if YES at S04), the system reads the pattern in the preceding frame from memory (at S05) and executes pattern matching with the pattern in the current frame (at S06). The pattern matching (at S06) searches for matching patterns (e.g., the circle and square shapes in (b1), (b2), and (c) in FIG. 3) by comparing the matching inspection area from the preceding frame with the matching inspection area from the following frame.

At step S07, the system checks whether matching has succeeded. If matching has succeeded (YES at S07), the system determines the characteristic points that match in the preceding frame and the following frame (point a and point b in (c) in FIG. 3) and stores their coordinates in memory at S08.

Next, at S09, the system converts coordinate values (the screen coordinate values) of each characteristic point in the preceding frame and the following frame to corresponding coordinate values on the road surface (subject point positions). If the mounting height H and the mounting angle of the camera are determined, as in FIG. 1B, the field angle of the camera is determined in advance, so if other factors such as lens system deflection and the like are taken into account, the correspondences between the coordinates of each position on the screen and positions on the road surface can be uniquely identified. In FIG. 1B, G is the position on the road surface that corresponds to the center of the screen.

Once the coordinate values (the screen coordinate values) of each characteristic point are converted to coordinate values on the road surface (subject point positions, as seen from the on-board camera), the system then determines the amount of displacement (movement amount) between the two subject point positions. If the time gap between the two frames is sufficiently short, the movement amount can be approximated by the distance between the two subject point positions (the length of a straight line connecting the two subject point positions). Note that, as described above, an automobile does not instantly turn at the same angle as the steering angle, but rather turns around a prescribed position (an axis of rotation) that is in a prescribed relationship to the steering angle. Therefore, if a movement amount is determined that follows the track of the turn, a more accurate movement amount can be obtained.

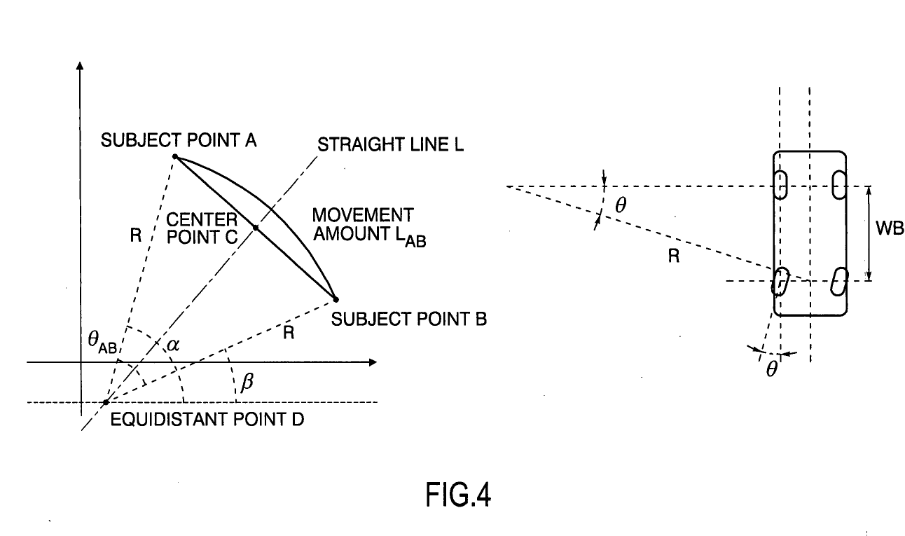

Next an exemplary technique for determining an approximate movement amount that follows the path of the turn will be explained. That is, the technique for determining the movement amount LAB in FIG. 4, based on turning information obtained at step S02, will be explained.

First, a center point C on a line segment AB that connects subject points A and B is determined. If A (X1, Y1), B (X2, Y2), C (X3, Y3), the coordinates of C may be expressed according to the following formula (1):
X3=(X1+X2)/2,Y3=(Y1+Y2)/2 (1)

Next, a straight line L is determined that intersects the line segment AB at point C. The slope a of the line segment AB may be expressed according to the following formula (2):
a=(Y2−Y1)/(X2−X1) (2)

Because the line passes through point C (X3, Y3), the intercept b is known, the straight line L may be expressed according to the following formula (3):
y=(−1/a)*x+b (3)

Based on the steering angle values at point A and point B, the respective front wheel steering angles q1 and q2 may be determined. Here, the front wheel steering angles q1 and q2 can be determined based on the turning characteristics of the vehicle.

The front wheel steering angle q during the approximated movement is determined using the front wheel steering angles q1 and q2. For example, the average value may be determined according to the following formula (4):
q=(q1+q2)/2 (4)

Next, the turning radius R is determined based on q. If the vehicle wheel base is WB, the radius is determined according to the following formula (5):
R=WB*tan(90−q) (5)

Next, the system determines point D (X0, Y0), a point on the straight line L for which the distance from points A and B is equal to R. The slope a and the intercept b are already known in the equation for the straight line L described above, so D is known.

Next, the system determines straight line AD and straight line BD, then determines the angles a and b that the straight lines AD and BD respectively form with the X axis (although the Y axis may also be used). When the straight lines AD and BD are respectively expressed as y=c*x+d and y=e*x+f, then a =tan−1 (c) and b=tan−1 (e).

Based on a and b, the angle qAB formed by the two straight lines AD and BD is expressed according to formula (6), as follows:
qAB=a−b (6)

Based on qAB and the turning radius R, the approximate movement amount LAB between points A and B is expressed according to the following formula (7):
LAB=R*qAB (7)
Note that the unit for qAB is the rad. In the equations above, the asterisk (*) signifies multiplication.

If the movement amount between the two subject points A and B is determined approximately in this manner, or if the movement amount between the two subject points A and B is determined more precisely by calculating the length of a path that follows the approximately circular arc in FIG. 4, the movement amount (in the case of a straight line approximation, a movement distance), and a movement velocity that is calculated based on the movement amount, are updated at S10.

According to the above exemplary method, when there is a matching failure (NO in S07) the current or preceding frame may be skipped. Note that where the current or preceding frame is skipped due to a matching failure, the movement velocity is calculated by taking into account the time that corresponds to the number of skipped frames. The values (movement amount, movement velocity) that are updated in this manner at S110 serve as data that are used for a variety of functions by the car navigation system.

Next, the program returns to step S01 and repeatedly executes the processing described above until the processing is ended (until the result at S11 is YES).

According to the above exemplary method, if the matching inspection area in the following frame is demarcated such that the identical characteristic points in the two frames are lined up in the vertical direction in the matching inspection areas extracted from both frames, the pattern matching processing load can be significantly reduced.

Also, if the matching inspection area in the following frame is demarcated as described above, the length of time that a given characteristic point remains within the matching inspection area can be increased, so it becomes possible to track the given characteristic point over a comparatively long period of time, reducing the possibility of a matching failure.

Generally, in the case of a matching failure, matching may be done between a preceding frame and a following frame, skipping over the frame, or the preceding frame is abandoned and matching is done between the current frame and the following frame, but in both cases, a frame exists that cannot be included in the matching process, causing a decrease in accuracy. However, rotating the matching inspection area as described above and then extracting it decreases the possibility of a decrease in accuracy due to a cause such as this.

According to the above exemplary systems and methods, the movement amount or movement distance may be precisely calculated with a comparatively small processing load when the direction of travel (that is, the direction of image capture) can change freely as the automobile moves.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A movement amount computation system that determines a movement amount of a moving body, comprising:
a controller that:
detects a steering angle of a moving body on which a camera is mounted;
extracts matching inspection areas of a prescribed shape and size from frames captured by the camera;
rotates the inspection area of a second frame relative to the inspection area of a first frame, the rotation based on the detected steering angle, the second frame following the first frame;
executes pattern matching between the inspection areas;
calculates positions of subject points that correspond to identical characteristic points in each frame;
determines a displacement amount between the calculated subject point positions in the first inspection area and the calculated subject point positions in the second subject point position; and
determines the movement amount of the moving body based on the determined displacement amount.

2. The system of claim 1, wherein the controller calculates the positions of the subject points relative to the camera.

3. The system of claim 2, wherein the controller calculates the positions of the subject points by converting a position of the subject points in screen area coordinates to a position of the subject points in road surface coordinates.

4. The system of claim 1, wherein the moving body is a vehicle.

5. A navigation system for a vehicle comprising the system of claim 1.

6. A movement amount computation system that determines a movement amount of a moving body, comprising:
a controller that:
detects a steering angle of a moving body executes pattern matching between frames captured by a camera mounted on the moving body;
calculates positions in relation to the camera of subject points that correspond to identical characteristic points in each of the matching frames;
calculates the length of a turning path of the moving body between the subject points of one of the matching frames and the subject points in another of the matching frames based on the detected steering angle; and
determines the movement amount based on the calculated length of the turning path.

7. The system of claim 6, wherein the moving body is a vehicle.

8. A navigation system for a vehicle comprising the system of claim 6.

9. A movement amount computation system that determines a movement amount of a moving body, comprising:
a controller that:
detects a steering angle of a moving body on which a camera is mounted
extracts matching inspection areas of a prescribed shape and size from frames captured by the camera;
rotates the inspection area of a second frame relative to the inspection area of a first frame, the rotation based on the detected steering angle, the second frame following the first frame;
executes pattern matching between the inspection areas;
calculates positions of subject points that correspond to identical characteristic points in each frame;
calculates the length of a turning path of the moving body between the subject points of the matching frames based on the detected steering angle; and
determines the movement amount based on the calculated length of the turning path.

10. The system of claim 9, wherein the moving body is a vehicle.

11. A navigation system for a vehicle comprising the system of claim 9.
